(19) United States
(12) Patent Application Publication
(10) Pub. No.: US 2025/0272547 A1
(43) Pub. Date: Aug. 28, 2025

(54) MIMETIC INITIALIZATION OF SELF-ATTENTION LAYERS

(71) Applicant: Robert Bosch GmbH, Stuttgart (DE)

(72) Inventors: Jeremy KOLTER, Pittsburgh, PA (US); Asher TROCKMAN, Pittsburgh, PA (US); Devin T. WILLMOTT, Pittsburgh, PA (US)

(21) Appl. No.: 18/586,116

(22) Filed: Feb. 23, 2024

(51) Int. Cl. G06N 3/0475

(52) U.S. Cl. CPC G06N 3/0475

(57) ABSTRACT

A method of initializing and training a transformer neural network including a plurality of self-attention layers configured to operate in accordance with a plurality of matrices includes determining structural relationships between respective parameters of the plurality of matrices, initializing the plurality of matrices based on the determined structural relationships, providing, as input, the plurality of matrices to the transformer neural network to initialize the transformer neural network for training, and generating, using the transformer neural network, an output based on the plurality of matrices.

### TECHNICAL FIELD

The present disclosure relates to initialization strategies for neural networks, and more particularly to initializing parameters in self-attention layers of transformer-based neural networks.

### BACKGROUND

Various systems configured to perform tasks using machine learning (ML) or other artificial intelligence (AI) techniques may include one or more neural networks. For example, neural networks may be implemented in systems configured to perform image recognition, object detection, natural language processing, and/or other automated tasks.

### SUMMARY

A method of initializing and training a transformer neural network including a plurality of self-attention layers configured to operate in accordance with a plurality of matrices includes determining structural relationships between respective parameters of the plurality of matrices, initializing the plurality of matrices based on the determined structural relationships, providing, as input, the plurality of matrices to the transformer neural network to initialize the transformer neural network for training, and generating, using the transformer neural network, an output based on the plurality of matrices.

In other features, the plurality of matrices includes a value matrix, a projection matrix, a query matrix, and a key matrix. Determining the structural relationships includes determining products of respective pairs of the plurality of matrices. Determining the structural relationships includes determining a first product of the value matrix and the projection matrix and a second product of the query matrix and the key matrix. The method further includes performing singular value decompositions based on the products of the respective pairs of the plurality of matrices. Performing the singular value decompositions includes using at least one of full-rank singular value decomposition factors and low-rank singular value decomposition factors. Determining the structural relationships includes determining diagonals of the products of the respective pairs of the plurality of matrices. Determining the structural relationships includes sampling a random normal matrix.

A computing device is configured to initialize and train a transformer neural network that includes a plurality of self-attention layers configured to operate in accordance with a plurality of matrices. The computing device includes a processing device configured to execute instructions stored in memory to determine structural relationships between respective parameters of the plurality of matrices, initialize the plurality of matrices based on the determined structural relationships, provide, as input, the plurality of matrices to the transformer neural network to initialize the transformer neural network for training, and generate, using the transformer neural network, an output based on the plurality of matrices.

In other features, the plurality of matrices includes a value matrix, a projection matrix, a query matrix, and a key matrix. To determine the structural relationships, the processing device is configured to execute instructions to determine products of respective pairs of the plurality of matrices. To determine the structural relationships, the processing device is configured to execute instructions to determine a first product of the value matrix and the projection matrix and a second product of the query matrix and the key matrix. The processing device is configured to execute instructions to perform singular value decompositions based on the products of the respective pairs of the plurality of matrices, and performing the singular value decompositions includes using at least one of full-rank singular value decomposition factors and low-rank singular value decomposition factors. To determine the structural relationships, the processing device is configured to execute instructions to determine diagonals of the products of the respective pairs of the plurality of matrices. To determine the structural relationships, the processing device is configured to execute instructions to sample a random normal matrix.

A system configured to train a transformer neural network including a plurality of self-attention layers configured to operate in accordance with a plurality of matrices includes data storage that stores training data for training the transformer neural network, memory that stores a data representation of the transformer neural network, and a processing device configured to iteratively train the neural network using the training data to obtain a trained transformer neural network. Iteratively training the transformer neural network includes initializing the transformer neural network by determining structural relationships between respective parameters of the plurality of matrices, initializing the plurality of matrices based on the determined structural relationships, and providing, as input, the plurality of matrices to the transformer neural network to initialize the transformer neural network for training by the processing device.

In other features, the plurality of matrices includes a value matrix, a projection matrix, a query matrix, and a key matrix. Determining the structural relationships includes determining products of respective pairs of the plurality of matrices. Determining the structural relationships includes determining a first product of the value matrix and the projection matrix and a second product of the query matrix and the key matrix. The processing device is configured to perform singular value decompositions based on the products of the respective pairs of the plurality of matrices, and performing the singular value decompositions includes using at least one of full-rank singular value decomposition factors and low-rank singular value decomposition factors. Determining the structural relationships includes determining diagonals of the products of the respective pairs of the plurality of matrices.

### BRIEF DESCRIPTION OF THE DRAWINGS

FIG. 1 generally illustrates a system for training a neural network according to the principles of the present disclosure.

FIG. 2 generally illustrates a computer-implemented method for training and utilizing a neural network according the principles of the present disclosure.

FIG. 3A generally illustrates an audio data labeling system according to the principles of the present disclosure.

FIG. 3B generally illustrates a portion of a data capturing system according to the principles of the present disclosure.

FIG. 3C generally illustrates an alternative audio data labeling system, according to the principles of the present disclosure.

FIGS. 4A and 4B generally illustrate example patterns in self-attention weights for a pre-trained transformer model.

FIG. 4C generally illustrates example attention maps in a vision transformer model for a variety of training settings according to the principles of the present disclosure;

FIG. 4D generally illustrates example modeling values of for mimetic initialization techniques according to the principles of the present disclosure;

FIG. 4E illustrates steps of an example mimetic initialization method according to the principles of the present disclosure.

FIG. 5 depicts a schematic diagram of an interaction between a computer-controlled machine and a control system according to the principles of the present disclosure.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to the principles of the present disclosure.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Neural networks (e.g., neural networks for ML and other AI systems) are typically trained using various training techniques, such as gradient decent training. Gradient descent training includes passing training examples through the neural network, measuring performance of the neural network with a loss function that compares the predictions of the neural network with the correct prediction, calculating the gradient of a loss function with respect to parameters of the neural network, and updating model parameters by subtracting the gradient of the model parameters, with the ultimate goal of decreasing the value of the loss function in future iterations.

The process of choosing starting values for parameters of the neural network is referred to as initialization. Initialization of a neural network includes setting initial values of various parameters, such as weights, biases, etc. For example, in some initialization techniques, neural network weights may be initialized at random from univariate distributions, by selecting parameters by sampling from a probability distribution, etc. These and other initialization techniques (e.g., Kaiming initialization, Xavier initialization, etc.) may include controlling only the variance of individual weights, even in highly-structured operations such as convolutions. In other words, each parameter of the neural network is initialized independently and there is no relationship or dependence between initial values of any pair of parameters (e.g., the covariance of any pair of parameters is 0).

A transformer-based neural network (a “transformer neural network”) is a type of neural network that implements a self-attention mechanism. Typically, a transformer neural network include multiple transformer layers (which may be referred to as self-attention layers). The self-attention layers may be implemented as encoders, decoders, or combinations thereof. The self-attention layers are configured to learn long-range dependencies in an input sequence (i.e., long-range dependencies between elements of an input sequence comprised of sequential data). Transformer neural networks may be used for natural language processing (NLP) tasks, speech processing, image recognition (e.g., Vision Transformer (ViT)-based tasks), etc.

Neural network initialization systems and methods of the present disclosure are configured to initialize parameters of self-attention layers of transformer-based neural networks. Rather than initializing parameters independently, systems and methods described herein (which may be referred to as mimetic initialization systems and methods) are configured to initialize parameters based on relationships or dependencies between the parameters such that the initialized parameters have a specific, desired structure. Accordingly, a transformer neural network initialized in accordance with the principles of the present disclosure trains more quickly (i.e., performance of the neural network improves more quickly during training) and achieves higher performance at the conclusion of training.

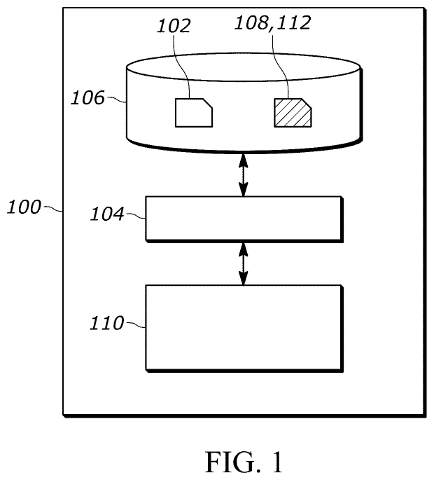

FIG. 1 shows one example system 100 for training a neural network (e.g., of an ML model). The system 100 may be configured to (and/or include circuitry configured to) implement the systems and methods of the present disclosure described below in more detail. The system 100 may comprise an input interface for accessing training data 102 for the neural network. For example, as illustrated in FIG. 1, the input interface may be constituted by a data storage interface 104 which may access the training data 102 from data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also external data storage, e.g., network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from different data storage, e.g., via a different subsystem of the data storage interface 104. Each subsystem may be of a type as is described above for the data storage interface 104.

In some embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive, as input, an output of a previous layer, or for a first layer of the stack of layers, an initial activation, and a part of the input of the stack of layers.

The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The processor subsystem 110 is configured to train the neural network in accordance with mimetic initialization systems and methods of the present disclosure as described below in more detail.

The system 100 may further comprise an output interface for outputting a data representation 112 of the trained neural network. This data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may, during or after the training, be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In some embodiments, the data representation 112 may be stored separately from the data representation 108 defining the ‘untrained’ neural network. In some embodiments, the output interface may be separate from the data storage interface 104, but may in general be of a type as described above for the data storage interface 104.

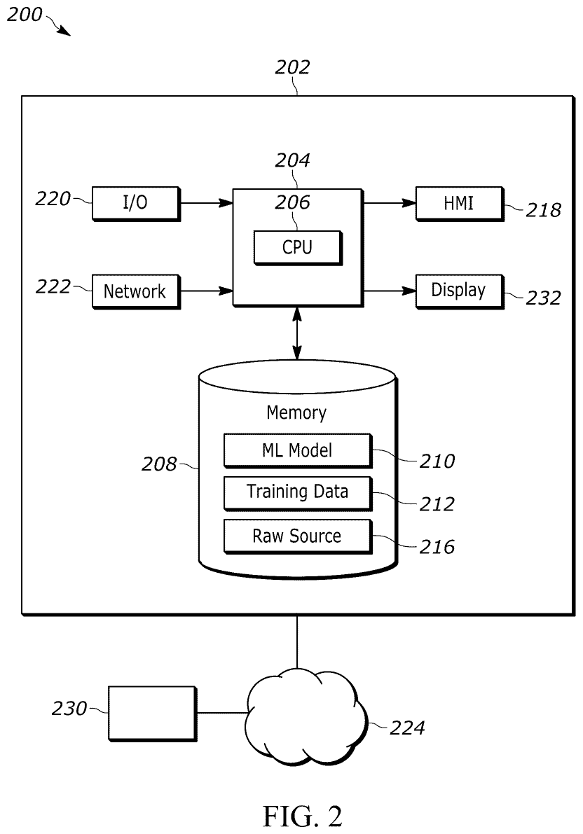

FIG. 2 depicts a data annotation/augmentation system 200 configured to (and/or including circuitry configured to) implement a system for annotating and/or augmenting data. The data annotation system 200 may include at least one computing system 202 configured to implement all or portions of the systems and methods of the present disclosure explained below in more detail. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. Various components of the system 200 may be implemented with same or different circuitry.

During operation, the CPU 206 may execute stored program instructions that are retrieved from the memory unit 208. The stored program instructions may include software that controls operation of the CPU 206 to perform the operation described herein. In some embodiments, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 (e.g., represented in FIG. 2 as the ML Model 210) or algorithm, a training dataset 212 for the machine-learning model 210, raw source dataset 216, etc.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 may include additional serial interfaces for communicating with external devices (e.g., Universal Serial Bus (USB) interface).

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning model 210 that is configured to analyze the raw source dataset 216. For example, the CPU 206 and/or other circuitry may implement the machine-learning model 210. The raw source dataset 216 may include raw or unprocessed sensor data that may be representative of an input dataset for a machine-learning system. The raw source dataset 216 may include video, video segments, images, audio, text-based information, and raw or partially processed sensor data (e.g., radar map of objects). In some embodiments, the machine-learning model 210 may be a deep-learning or neural network algorithm that is designed to perform a predetermined function. For example, the neural network algorithm may be configured to identify events or objects in video segments based on audio data.

The computer system 200 may store the training dataset 212 for the machine-learning model 210. The training dataset 212 may represent a set of previously constructed data for training the machine-learning model 210. The training dataset 212 may be used by the machine-learning model 210 to learn weighting factors associated with a neural network algorithm. The training dataset 212 may include a set of source data that has corresponding outcomes or results that the machine-learning model 210 tries to duplicate via the learning process.

The machine-learning model 210 may be operated in a learning mode using the training dataset 212 as input. The machine-learning model 210 may be executed over a number of iterations using the data from the training dataset 212. With each iteration, the machine-learning model 210 may update internal weighting factors based on the achieved results. For example, the machine-learning model 210 can compare output results (e.g., annotations) with those included in the training dataset 212. Since the training dataset 212 includes the expected results, the machine-learning model 210 can determine when performance is acceptable. After the machine-learning model 210 achieves a predetermined performance level (e.g., 100% agreement with the outcomes associated with the training dataset 212), the machine-learning model 210 may be executed using data that is not in the training dataset 212. The trained machine-learning model 210 may be applied to new datasets to generate annotated data. The machine-learning model 210 may include a neural network trained in accordance with mimetic initialization systems and methods of the present disclosure.

The machine-learning model 210 may be configured to identify a particular feature in the raw source data 216. The raw source data 216 may include a plurality of instances or input dataset for which annotation results are desired (e.g., a video stream or segment including audio data). For example only, the machine-learning model 210 may be configured to identify objects or events in a video segment based on audio data and annotate the events. The machine-learning model 210 may be programmed to process the raw source data 216 to identify the presence of the particular features. The machine-learning model 210 may be configured to identify a feature in the raw source data 216 as a predetermined feature. The raw source data 216 may be derived from a variety of sources. For example, the raw source data 216 may be actual input data collected by a machine-learning system. The raw source data 216 may be machine generated for testing the system. As an example, the raw source data 216 may include raw video and/or audio data from a camera, audio data from a microphone, etc.

In an example, the machine-learning model 210 may process raw source data 216 and output video and/or audio data including one or more indications of an identified event. The machine-learning model 210 may generate a confidence level or factor for each output generated. For example, a confidence value that exceeds a predetermined high-confidence threshold may indicate that the machine-learning model 210 is confident that the identified event (or feature) corresponds to the particular event. A confidence value that is less than a low-confidence threshold may indicate that the machine-learning model 210 has some uncertainty that the particular feature is present.

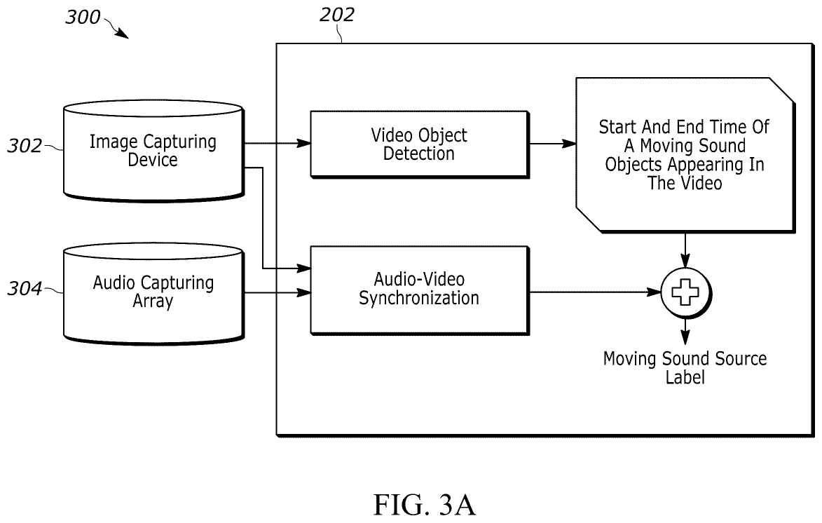

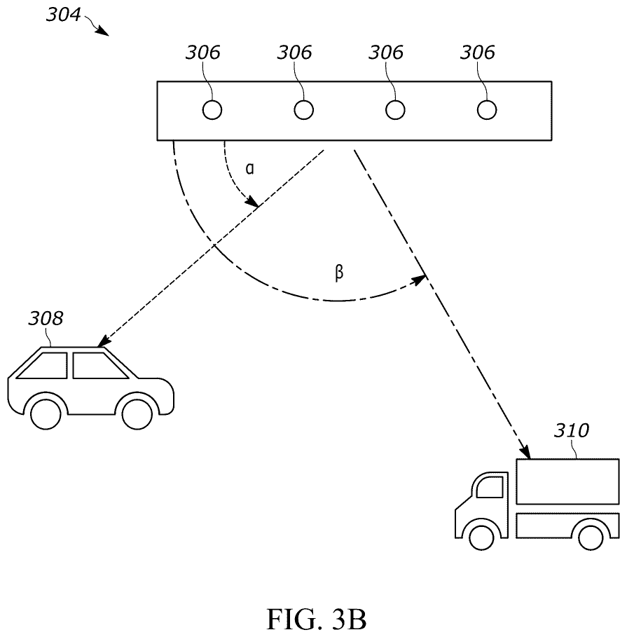

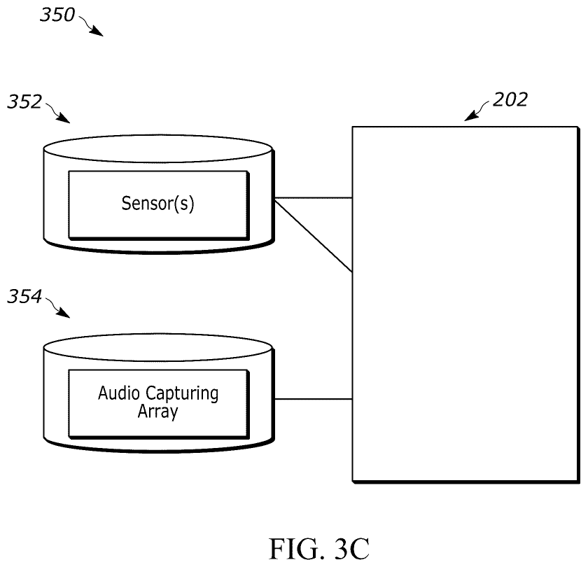

As is generally illustrated in FIGS. 3A and 3B, a system 300 may include an image (e.g., video) capturing device 302, an audio capturing array 304, and the computing system 202. The system may receive, from the image capturing device 302, video stream data associated with a data capture environment. The system 202 may be configured to perform video object detection to identify one or more objects in corresponding images of the video stream data. The system 202 may receive, from the audio capturing array 304, audio stream data that corresponds to at least a portion of the video stream data. The audio capturing array 304 may include one or more microphones 306 or other suitable audio capturing devices. The systems and methods described herein may be configured to label, using output from at least a first machine-learning model (e.g., such as the machine-learning model 210 or other suitable machine-learning model configured to provide output including one or more object or event detection predictions), at least some objects of the video stream data and/or audio stream data.

The system 202 may calculate (e.g., using at least one probabilistic-based function or other suitable technique or function), based on at least one data capturing characteristic, at least one offset value for at least a portion of the audio stream data that corresponds to at least one labeled object of the video stream data. The system 202 may synchronize, using at least the at least one offset value, at least a portion of the video stream data with the portion of the audio stream data that corresponds to the at least one labeled object of the video stream data. The at least one data capturing characteristic may include one or more characteristics of the at least one image capturing device, one or more characteristics of the at least one audio capturing array, one or more characteristics corresponding to a location of the at least one image capturing device relative to the at least one audio capturing array, one or more characteristics corresponding to a movement of an object in the video stream data, one or more other suitable data capturing characteristics, or a combination thereof.

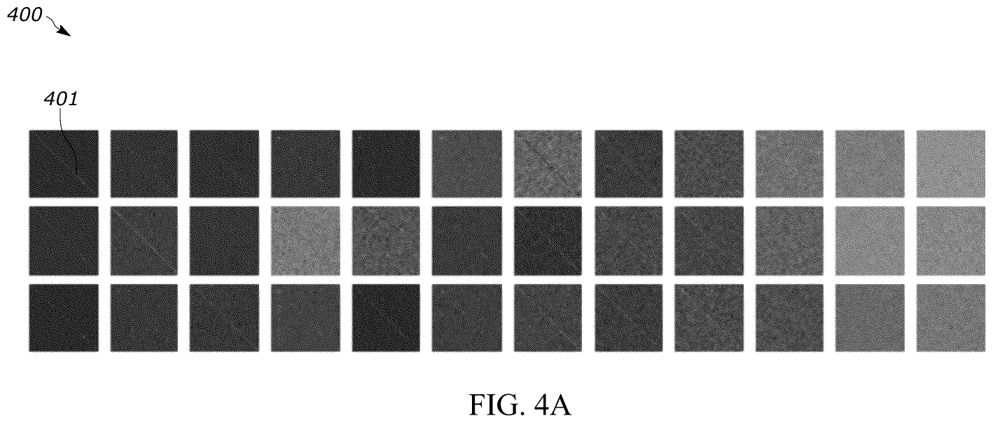

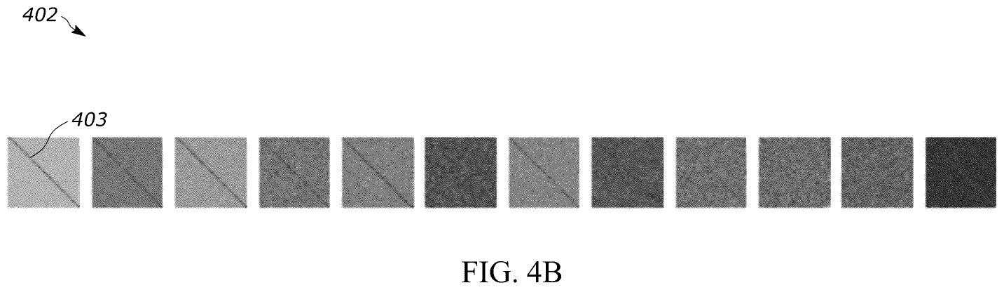

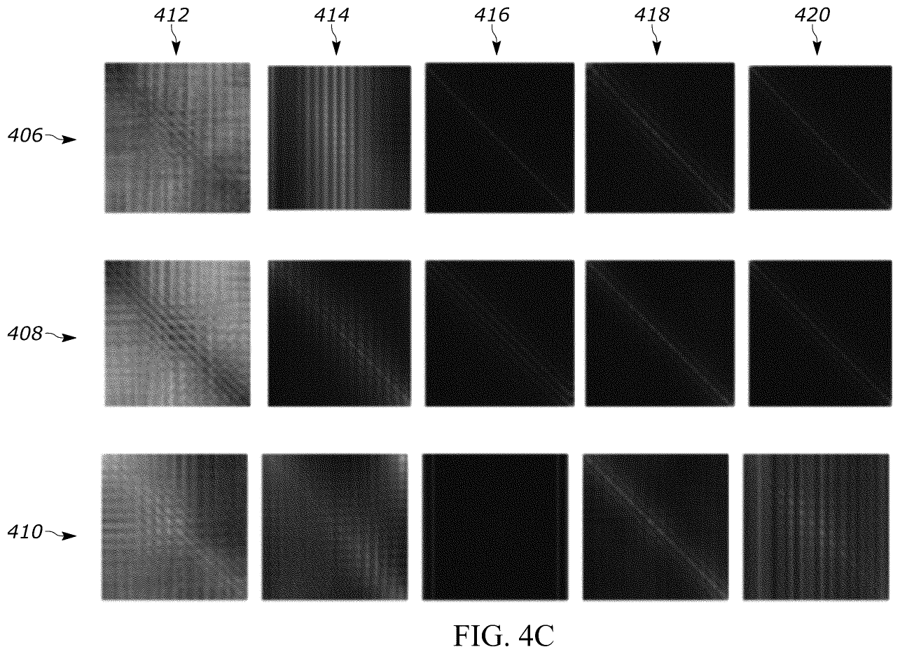

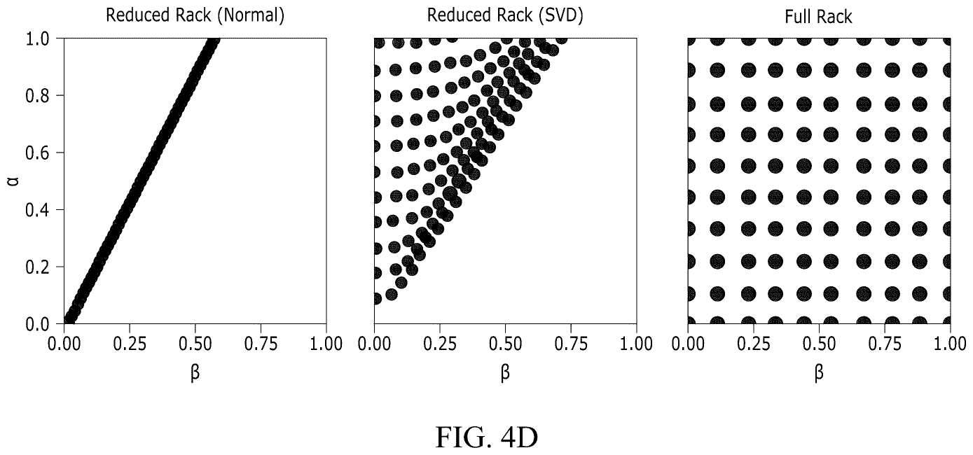

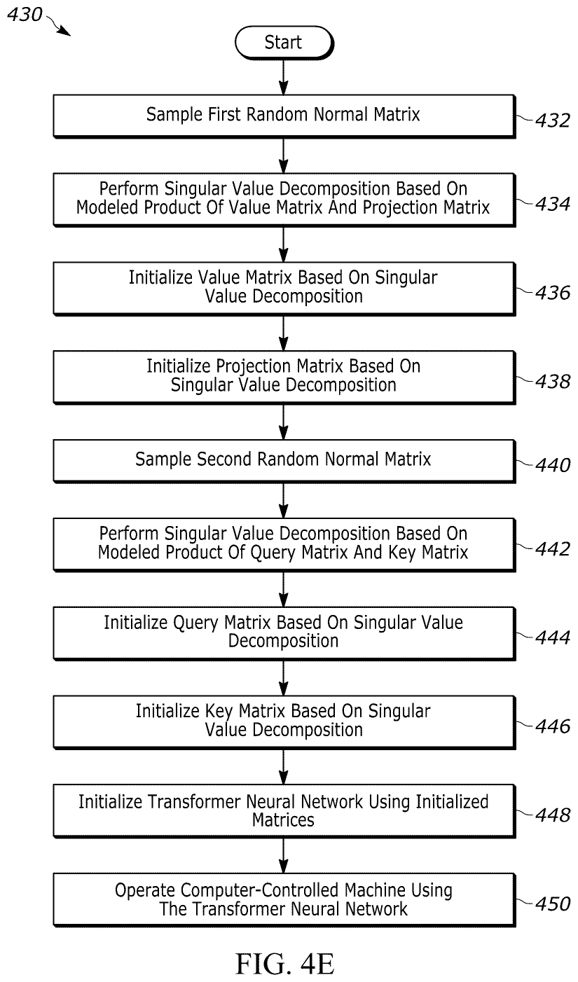

The system 202 may label, using one or more labels of the labeled objects of the video stream data and the at least one offset value, at least the portion of the audio stream data that corresponds to the at least one labeled object of the video stream data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model. The second machine-learning model may include any suitable machine-learning model and may be configured to perform any suitable function, such as those described herein with respect to FIGS. 4-11.

In some embodiments, as is generally illustrated in FIG. 3C, the computing system 202 may be configured to label audio data based on sensor data received from one or more sensors, such as those described herein or any other suitable sensor or combination of sensors. The system 202 may receive, from the audio capturing array 354 or any suitable audio capturing device, such as one or more of the microphones 306 or other suitable audio capturing device, audio stream data associated with a data capture environment. It should be understood that the audio capturing array 354 may include features similar to those of the audio capturing array 304 and may include any suitable number of audio capturing devices. The system 202 may receive, from at least one sensor (e.g., such as the sensor 352) that is asynchronous relative to the audio capturing array 354, sensor data associated with the data capture environment. The sensor 354 may include at least one of an induction coil, a radar sensor, a LiDAR sensor, a sonar sensor, an image capturing device, any other suitable sensor, or a combination thereof. The audio capturing array 354 may be remotely located from the sensor 354, proximately located to the sensor 354, or located in any suitable relationship to the sensor 354.

The system 202 may identify, using output from at least a first machine learning model, such as the machine learning model 210 or other suitable machine learning model, at least some events in the sensor data. The machine learning model 210 may be configured to provide output including one or more event detection predictions based on the sensor data. The system 202 may synchronize at least a portion of the sensor data associated with the portion of the audio stream data that corresponds to the at least one event of the sensor data. The system 202 may label, using one or more labels extracted for respective events of the sensor data value, at least the portion of the audio stream data that corresponds to the at least one event of the sensor data. Each respective label may include an event type, an event start indicator, and an event end indicator. The system 202 may generate training data using at least some of the labeled portion of the audio stream data. The system 202 may train a second machine-learning model using the training data. The system 202 may detect, using the second machine-learning model, one or more sounds associated with audio data provided as input to the second machine-learning model. The second machine-learning model may include any suitable machine-learning model and may be configured to perform any suitable function, such as those described herein with respect to FIGS. 4-11.

Any of the systems described herein may implement the mimetic initialization systems and methods of the present disclosure as described below in more detail.

Transformers are difficult to train on small datasets. Accordingly, large pre-trained transformer models (e.g., pre-trained ViTs) are used. In pre-trained ViTs, the weights of self-attention layers are often quite correlated, in that W_{Q}W_{K}^{T}∝I+ε and W_{V}W_{prof}∝ε−I. Accordingly, memetic initialization systems and methods according to the present disclosure initialize the self-attention weights to mimic this observation, and in some examples use standard sinusoidal position embeddings. Initializing the weights of self-attention layers of transformers to resemble the structures and patterns observed in weights of pre-trained transformers allows “vanilla” (i.e., untrained/unmodified) transformers to be trained more quickly and to higher final accuracies, particularly on vision tasks. This initialization scheme is closed form and learning-free and includes setting the product of the query and key weights to be approximately the identity (i.e., input data that is passed through the neural network without any changes) and the product of the value and projection weights to approximately the negative identity. As this mimics the patterns observable in pre-trained transformers, this technique is referred to herein as “mimetic initialization.”

As described herein, mimetic initialization systems and methods use interpretable formulas and do not include any pre-training or learning procedures. ViTs initialized in this manner are more easily trainable without the use of convolutions. As an example, controlling the behavior of the query and key weights replicates the behavior of pre-trained models without performing actual pre-training. Mimetic initialization does not require structural changes to the transformer.

In an example, query and key weight matrices for a single head of self-attention can be denoted by W_{Q}, W_{K}∈ [symbol] , where d is the dimension (or width) of the transformer and k=d/#heads is the head dimension. The value and projection matrices can be considered to be full-rank in accordance with W_{V}, Wₚᵣₒⱼ∈ [symbol] . For inputs X∈ [symbol] with additive positional embeddings P∈ [symbol] , an “attention map” can be defined as follows:

$$Softmax ( \frac{1}{\sqrt{k}} {XW}_{Q} {W}_{K}^{T} {X}^{T} ) .$$

As stated above, mimetic initialization is based on mimicking the patterns observed in pre-trained vision transformers. FIGS. 4A and 4B illustrate example patterns in self-attention weights for a pre-trained ViT-Tiny transformer model. As shown at 400, W_{Q}W_{K}^{T} (the product of the query matrix and the key matrix) often has a noticeable positive diagonal (i.e., main diagonal) 401. Conversely, as shown at 402, W_{V}Wₚᵣₒⱼ^{T} the product of the value matrix and the projection matrix) often has a noticeable negative diagonal 403. This behavior is similar in ViTs of different sizes, which suggests that W_{Q} and W_{K} may be same or similar low-rank random normal matrices, as such matrices are approximately semi-orthogonal. For example, an appropriately-scaled random normal matrix is approximately orthogonal. In other words, if Z∈ [symbol] and Z˜ [symbol] (0,I/k), then ZZ^{T̅}≈I. On language models a similar pattern is observable.

FIG. 4C illustrates example attention maps in a ViT-Tiny transformer model for a variety of training settings, averaged over three heads (e.g., shown at 406, 408, and 410, corresponding to different layers) and over a batch of inputs. Results for an untrained model are shown at 412. Results for an example pre-trained model are shown at 414. Results for another example pre-trained model are shown at 416. Results for an untrained model initialized using the mimetic initializing techniques of the present disclosure are shown at 418. Results for a model initialized using the mimetic initializing techniques of the present disclosure and then trained are shown at 420. As shown, there are observable differences between the results of the untrained model 412 and the results of the untrained model 418 initialized in accordance with the initializing techniques of the present disclosure. Conversely, there are observable similarities between the results of the pre-trained model 416 and the results of the untrained model 418 initialized in accordance with the initializing techniques of the present disclosure. After training, results of the model initialized in accordance with the initializing techniques of the present disclosure as shown at 420 have similarities to both the results of the pre-trained model 416 (e.g., for layers corresponding to 406 and 408) and the pre-trained model 416 (e.g., for a layer corresponding to 410.

Example modeling techniques for modeling structural relationships between a query matrix and a key matrix and a between a value matrix and a projection matrix (e.g., products W_{Q}W_{K}^{T} and W_{V}Wₚᵣₒⱼ) are described below. In one example, the two matrices in the product are set to the same random normal matrix W_{Q}=W_{K}=N(0, 1/k), which is scaled by the transformer head dimension k so that the average magnitude of the diagonal is ≈1. In the case of the value/projection matrices, the corresponding equation is:

$$Z := N ( 0 , I / d ) , {W}_{V} = Z , {W}_{proj} = - Z .$$

However, no matter how the random normal matrix is scaled, the ratio between the magnitude of the on-diagonal and the off-diagonal noise remains the same. Accordingly, to gain more flexibility in the prominence of the diagonal, another example modeling technique includes modeling the product according to:

$${W}_{Q} {W}_{K}^{T} \approx {α}_{1} {Z}_{1} + {β}_{1} I$$

$${W}_{V} {W}_{proj}^{T} \approx {α}_{2} {Z}_{2} + {β}_{2} I ,$$

where +β₁I corresponds to a positive diagonal and −β₂I corresponds to a negative diagonal, Zᵢ corresponds to noise as a sampling of a random normal matrix in accordance with

$${Z}_{i} \sim 𝒩 ( 0 , \frac{1}{d} I ) ,$$

and αᵢ, βᵢ∈[0,1] In this manner, the tradeoff between the noise Zᵢ and the diagonal I can be explicitly controlled by selecting the parameters αᵢ,βᵢ. To recover the factors W_{V}, Wₚᵣₒⱼ, the singular value decomposition (SVD) is used, as follows:

$${α}_{1} {Z}_{1} + {β}_{1} I = {U}_{1} {Σ}_{1} {V}_{1}^{T} \\ {W}_{V} := {U}_{1} {Σ}_{1} , {W}_{proj} := {V}_{1} {Σ}_{1}^{1 / 2} ,$$

and for the low-rank factors W_{Q}, W_{K}^{T}, the reduced SVD corresponds to:

$${α}_{2} {Z}_{2} + {β}_{2} I = {U}_{2} {Σ}_{2} {V}_{2}^{T} \\ {W}_{Q} := {U}_{2} [ : , : k ] {{Σ}_{2} [ : k , : k ]}^{1 / 2} \\ {W}_{K} := {V}_{2} [ : , : k ] {{Σ}_{2} [ : k , : k ]}^{1 / 2} .$$

In this example, Z₂ is resampled for each head.

FIG. 4D shows example values of α,β that can be achieved through the two example modeling techniques described above. Using equal random normal matrices, a linear relationship between α and β is observable for both low-rank and full-rank matrices. Using the SVD technique, a wider variety of selections can be achieved even in a low-rank case.

The mimetic initialization techniques of the present disclosure result in attention maps with a strong diagonal component that reflect the structure of the position embeddings, which can be denoted by P∈ [symbol] (generally illustrated in FIG. 4C). The corresponding values can also be roughly calculated. In an example, assuming that X∈ [symbol] and X˜ [symbol] (0,I) that W_{Q}, W_{K} are full rank, and that W_{Q}W_{K}^{T}=αZ+βI due to the mimetic initialization techniques described herein, [symbol] [(X+P)(αZ+βI)(X+P)^{T}]=βdI+βPP^{T}, as the only products with non-zero mean are XX^{T}≈I (on the diagonal) and PP^{T}. Accordingly, mimetic initialization results in expected attention maps of the form:

$$Softmax ( \frac{1}{\sqrt{k}} ( {β}_{1} dI + {β}_{1} {PP}^{T} ) ) .$$

In other words, mimetic initialization may bias attention maps towards mixing nearby tokens according to the structure of PP^{T}, which can be seen in FIG. 4C.

Mimetic initialization according to the present disclosure may further include the use of sinusoidal position embeddings instead of randomly initialized embeddings to improve accuracy.

As described above, mimetic initialization techniques for transformers are particularly effective at improving performance on small-scale image recognition tasks, leading to an increase of over 5% accuracy in some examples. Accordingly, the difficulty associated with training ViTs is addressed solely through a structured initialization of the weights, without need for any pre training or architectural modifications. These techniques may also be applied to improve language modeling on relatively small datasets.

FIG. 4E illustrates steps of an example implementation of a mimetic initialization method 430 for initializing self-attention layers in transformer neural networks according to the present disclosure. For example, one or more processors or processing devices are configured to execute instructions to implement the method 430, such as one or more of the processors of the systems described herein. In this example, self-attention layers have the following parameters (e.g., matrices of weights):
W_{Q}⁽ⁱ⁾∈R^{d×k} for i=1, . . . , h (a query matrix);
W_{K}⁽ⁱ⁾∈R^{d×k} for i=1, . . . , k (a key matrix);
W_{V}∈R^{d×d} (a value matrix); and
Wₚᵣₒⱼ∈R^{d×d} (a projection matrix);
where d is the dimension of the input, h is the number of self-attention heads, and k is the dimension of each input head (so k=d/h). A self-attention layer receives an input X∈R^{n×d} and operates on the input via the following algorithm:

$$1 ) {X}_{V} = {XW}_{V} ( so {X}_{V} ∈ {R}^{n \times d} ) .$$

2) Split X_{V} along its second dimension into h parts, which can be denoted as X_{V}⁽ⁱ⁾ for i=1, . . . , h (so X_{V}∈R^{n×k}).

3) For i=1, . . . , h:

A.

$${H}^{( i )} = softmax ( ( \frac{1}{\sqrt{k}} ) {{XW}_{Q} ( {W}_{K}^{( i )} )}^{T} {X}^{T} ) {X}_{V}^{( i )}$$

(compute self-attention map for head i).

4) Concatenate H⁽ⁱ⁾ for i=1, . . . , h along its second dimension, resulting in a matrix H∈R^{n×d}.

5) Multiply HWₚᵣₒⱼ

Mimetic initialization according to the present disclosure is based on the empirical observation that, in some example trained networks, the product of W_{Q}⁽ⁱ⁾ and W_{K}⁽ⁱ⁾^{^{T}} tend to have positive diagonal entries and the product of W_{V} and Wₚᵣₒⱼ tends to have negative diagonal entries.

As used herein, “sampling a random normal matrix” may refer to the notation

$$Z \sim 𝒩 ( 0 , \frac{I}{k} ) ,$$

where Z is a matrix where each entry is sampled from a Gaussian distribution with mean 0 and variance 1/k.

An example mimetic initialization method implements an algorithm TransformerInit(d, h, k, α₁, β₁, α₂, β₂) with the following inputs:
Layer dimension d;
Number of attention heads h;
Dimension per attention head k; and
Hyperparameters α₁, β₁, α₂, β₂.

The algorithm is implemented as follows:

1) Initialize W_{V} and Wₚᵣₒⱼ:

A. Sample random normal matrix

$${Z}_{1} \sim 𝒩 ( 0 , \frac{I}{k} )$$

B. U₁Σ₁V₁^{T}←αZ₁+β₁I (singular value decomposition of α₁Z₁+β₁I)

$$C . {W}_{V} ← {U}_{1} {Σ}_{1}^{\frac{1}{2}} \\ D . {W}_{proj} ← {V}_{1} {Σ}_{1}^{\frac{1}{2}}$$

2) Initialize W_{Q} and Wₖ:

A. For i=1, . . . , h:

i. Sample random normal matrix

$${Z}_{2} \sim 𝒩 ( 0 , \frac{I}{k} )$$

ii. U₂Σ₂V₂^{T}←αZ₂+β₂I (singular value decomposition of α₂Z₂+β₂I)

$$iii . {W}_{Q}^{( i )} ← {U}_{2} [ : , : k ] {Σ}_{2}^{\frac{1}{2}} [ : k , : k ] \\ iv . {W}_{K}^{( i )} ← {V}_{2} [ : , : k ] {Σ}_{2}^{1 / 2} [ : k , : k ]$$

Accordingly, the method 430 includes, at 432, a step of sampling a (first) random normal matrix as

$${Z}_{1} \sim 𝒩 ( 0 , \frac{I}{k} )$$

as described above. At 434, the method 430 performs a singular value decomposition of α₁Z₁+β₁I based on a modeled product of W_{V} and Wₚᵣₒⱼ. At 436, the value matrix W_{V} is initialized based on the singular value decomposition performed at 434 in accordance with

$${U}_{1} {Σ}_{1}^{\frac{1}{2}} .$$

At 438, the projection matrix Wₚᵣₒⱼ is initialized based on the singular value decomposition performed at 434 in accordance with

$${V}_{1} {Σ}_{1}^{\frac{1}{2}} .$$

At 440, the method 430 includes a step of sampling a (second) random normal matrix

$${Z}_{2} \sim 𝒩 ( 0 , \frac{I}{k} ) .$$

At 442, the method 430 performs a singular value decomposition of α₂Z₂+β₂I based on a modeled product of W_{Q}⁽ⁱ⁾ and W_{K}⁽ⁱ⁾. At 444, the query matrix W_{Q}⁽ⁱ⁾ is initialized based on the singular value decomposition performed at 442 in accordance with U₂Σ₂V₂^{T}. At 446, the key matrix W_{K}⁽ⁱ⁾ is initialized based on the singular value decomposition performed at 442 in accordance with U₂Σ₂V₂^{T}.

At 448, a transformer neural network is initialized using matrices W_{V}, Wₚᵣₒⱼ, W_{Q}⁽ⁱ⁾, and W_{K}⁽ⁱ⁾ initialized as described above and trained accordingly. In other words, since the matrices are populated in accordance with mimetic initialization techniques described herein, the transformer neural network is initialized using parameters that correspond to structural relationships between pairs of parameters. In an example, the processor subsystem 110 as described above in FIG. 1 is configured to train the neural network using these matrices as initialization inputs.

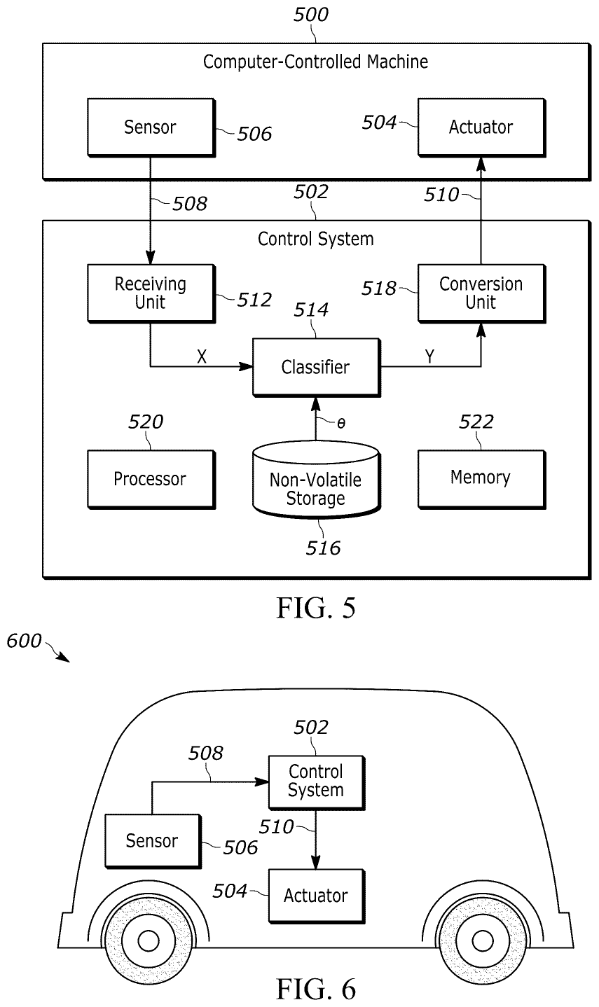

At 450, a computer-controlled machine is operated using the transformer neural network initialized at 448. For example, the computer-controlled machine may correspond to any of the systems or devices described below in FIGS. 5-11.

FIGS. 5-11 depict example systems and devices that may implement mimetic initialization systems and methods according to the present disclosure. FIG. 5 depicts a schematic diagram of an interaction between a computer-controlled machine 500 and control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. In some embodiments, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to produce each input signal x. Input signal x may include data corresponding to an image recorded by sensor 506.

Control system 502 includes classifier 514. Classifier 514 may be configured to classify input signals x into one or more labels using a machine-learning (ML) algorithm, such as a neural network. For example, the classifier 514 corresponds to the classifier 408 described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In some embodiments, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In some embodiments, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., ML algorithms) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more anomaly detection methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the anomaly detection methodologies as disclosed herein. Non-volatile storage 516 may also include data supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. Alternatively or in addition to one or more specific sensors identified above, sensor 506 may include a software module configured to, upon execution, determine a state of actuator 504. One non-limiting example of a software module includes a weather information software module configured to determine a present or future state of the weather proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects.

In some embodiments, the vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In a scenario where an adversarial attack may occur, the system described above may be further trained to better detect objects or identify a change in lighting conditions or an angle for a sensor or camera on vehicle 600.

In some embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may avoid collisions with identified objects.

In some embodiments, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

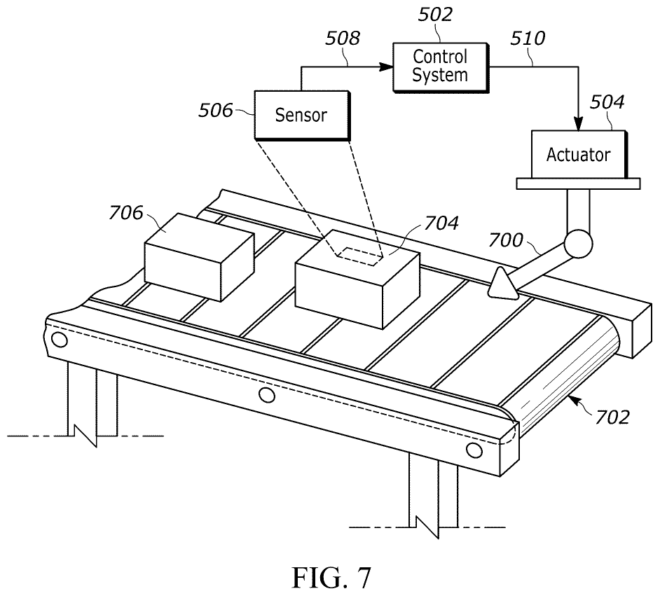

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 706 of system 700 (e.g., manufacturing machine) depending on the determined state of manufactured product 704.

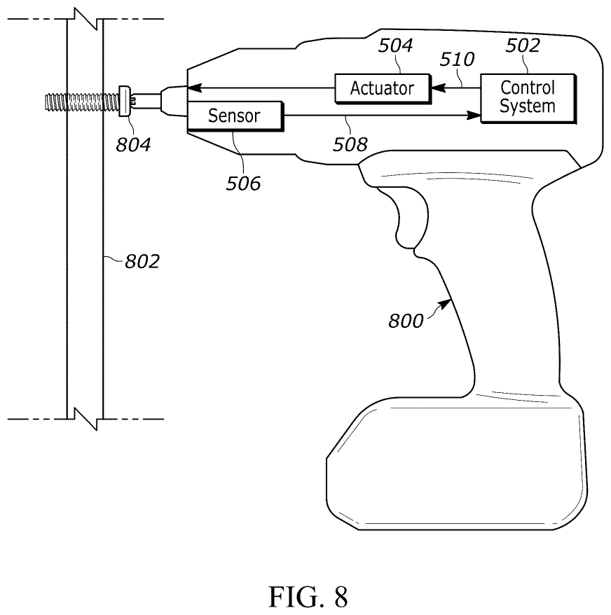

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more properties of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802.

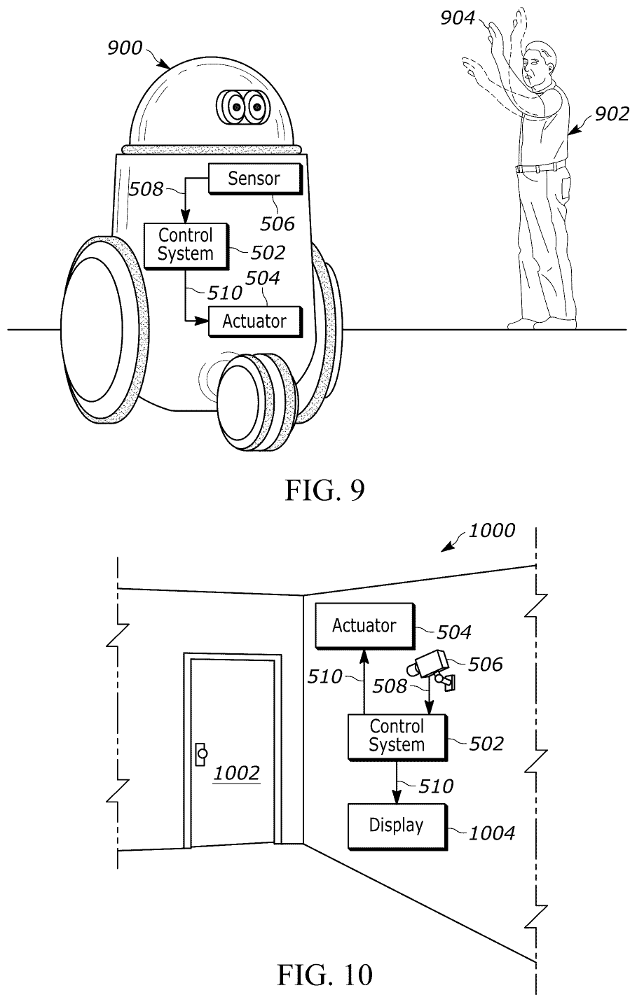

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In some embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object that is deemed suspicious by classifier 514. Utilizing an embodiment of the system disclosed, the surveillance system may predict objects at certain times in the future showing up.

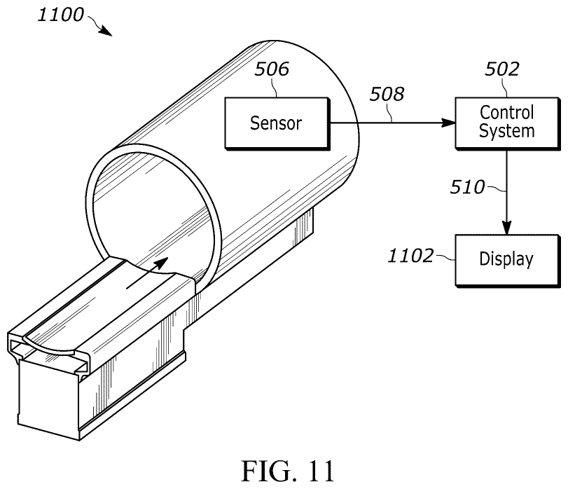

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to be potentially anomalous. In this case, actuator control command 510 may be determined or selected to cause display 1102 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of initializing and training a transformer neural network, wherein the transformer neural network includes a plurality of self-attention layers configured to operate in accordance with a plurality of matrices, the method comprising:
determining structural relationships between respective parameters of the plurality of matrices;
initializing the plurality of matrices based on the determined structural relationships;
providing, as input, the plurality of matrices to the transformer neural network to initialize the transformer neural network for training; and
generating, using the transformer neural network, an output based on the plurality of matrices.

2. The method of claim 1, wherein the plurality of matrices includes a value matrix, a projection matrix, a query matrix, and a key matrix.

3. The method of claim 2, wherein determining the structural relationships includes determining products of respective pairs of the plurality of matrices.

4. The method of claim 3, wherein determining the structural relationships includes determining (i) a first product of the value matrix and the projection matrix and (ii) a second product of the query matrix and the key matrix.

5. The method of claim 3, further comprising performing singular value decompositions based on the products of the respective pairs of the plurality of matrices,
wherein performing the singular value decompositions includes using at least one of full-rank singular value decomposition factors and low-rank singular value decomposition factors.

6. The method of claim 2, wherein determining the structural relationships includes determining diagonals of the products of the respective pairs of the plurality of matrices.

7. The method of claim 1, wherein determining the structural relationships includes sampling a random normal matrix.

8. A computing device configured to initialize and train a transformer neural network, wherein the transformer neural network includes a plurality of self-attention layers configured to operate in accordance with a plurality of matrices, the computing device including a processing device configured to execute instructions stored in memory to:
determine structural relationships between respective parameters of the plurality of matrices;
initialize the plurality of matrices based on the determined structural relationships;
provide, as input, the plurality of matrices to the transformer neural network to initialize the transformer neural network for training; and
generate, using the transformer neural network, an output based on the plurality of matrices.

9. The computing device of claim 8, wherein the plurality of matrices includes a value matrix, a projection matrix, a query matrix, and a key matrix.

10. The computing device of claim 9, wherein, to determine the structural relationships, the processing device is configured to execute instructions to determine products of respective pairs of the plurality of matrices.

11. The computing device of claim 10, wherein, to determine the structural relationships, the processing device is configured to execute instructions to determine (i) a first product of the value matrix and the projection matrix and (ii) a second product of the query matrix and the key matrix.

12. The computing device of claim 10, wherein the processing device is configured to execute instructions to perform singular value decompositions based on the products of the respective pairs of the plurality of matrices, and wherein performing the singular value decompositions includes using at least one of full-rank singular value decomposition factors and low-rank singular value decomposition factors.

13. The computing device of claim 9, wherein, to determine the structural relationships, the processing device is configured to execute instructions to determine diagonals of the products of the respective pairs of the plurality of matrices.

14. The computing device of claim 8, wherein, to determine the structural relationships, the processing device is configured to execute instructions to sample a random normal matrix.

15. A system configured to train a transformer neural network, wherein the transformer neural network includes a plurality of self-attention layers configured to operate in accordance with a plurality of matrices, the system comprising:
data storage that stores training data for training the transformer neural network;
memory that stores a data representation of the transformer neural network; and
a processing device configured to iteratively train the neural network using the training data to obtain a trained transformer neural network, wherein iteratively training the transformer neural network includes initializing the transformer neural network by
determining structural relationships between respective parameters of the plurality of matrices,
initializing the plurality of matrices based on the determined structural relationships, and
providing, as input, the plurality of matrices to the transformer neural network to initialize the transformer neural network for training by the processing device.

16. The system of claim 15, wherein the plurality of matrices includes a value matrix, a projection matrix, a query matrix, and a key matrix.

17. The system of claim 16, wherein determining the structural relationships includes determining products of respective pairs of the plurality of matrices.

18. The system of claim 17, wherein determining the structural relationships includes determining a first product of the value matrix and the projection matrix and a second product of the query matrix and the key matrix.

19. The system of claim 17, wherein the processing device is configured to perform singular value decompositions based on the products of the respective pairs of the plurality of matrices, and wherein performing the singular value decompositions includes using at least one of full-rank singular value decomposition factors and low-rank singular value decomposition factors.

20. The system of claim 16, wherein determining the structural relationships includes determining diagonals of the products of the respective pairs of the plurality of matrices.
